(19) United States
(12) Patent Application Publication
(10) Pub. No.: US 2004/0177659 A1
(43) Pub. Date: Sep. 16, 2004

(54) Deadbolt vinyl gate fence lock and system

(76) Inventors: LeRoy D. Dauterive, Terrytown, LA (US); Jerry G. Baker, Houma, LA (US)

Correspondence Address: Seth M. Nehrbass, Patent Attorney, Suite 3290, 3838 North Causeway Boulevard, Metairie, LA, 70002, US

(21) Appl. No.: 10/387,028

(22) Filed: Mar. 12, 2003

(51) Int. Cl. E05B 65/06

(52) U.S. Cl. 70/134

(57) ABSTRACT

The field of art of the invention is locking mechanisms for gates for vinyl fencing. The field of art encompasses the following classes and subclasses: 70/56, 129, 417, 421, 451, 93, 134, 139, and 292/337.

The invention is an apparatus of joined parts that allows the locking of a gate framed in vinyl parts to a stationary post made of vinyl. The stationary vinyl post is typically hollow with the walls of the post being typically of a thickness of no more than ⅜ of an inch and the outer diameter of the gate framing and post typically ranging from 3½ inches by 3½ inches square to 5 inches by 5 inches square in size. Sometimes the inside walls of the fence posts are lined with a metal sleeve for strength but the interior remains hollow. The gate's framing is typically made of vinyl framing members that have an outer thickness from 1 inch to 5 inches. The gate frames are also typically hollow inside the walls of the framing members with the walls of the gate framing being typically of a thickness of approximately ⅛ of an inch. Sometimes the inside walls of the gate framing are lined with joined metal sleeves for strength. The gate framing is connected to a second stationary fence post with hinges. The invented lock can be mounted to either a gate frame or to a fence post dependent upon thickness of each, however, the preferred installation calls for the deadbolt lock and cup or cups to be installed in the stationary fence post that does not have hinges.

The invented apparatus includes a kit where round or square or rectangular cups that are preferably approximately 3¼ inches in diameter and that have overlapping top flanges of at least ⅛ inches wide are inserted into and fit snugly in holes drilled or cut into the sides of a hollow vinyl fence post with the top flange of each cup (i.e. lip of the cup) overlapping and preventing the cups from being drawn through the holes; said cups being deep enough to accept the installation of standard home deadbolt locks that are designed to be installed on 1¼ inch to 1⅞ inch thick doors of homes, and where the deadbolt lock throw is installed to extend through a parallel hole of approximately 1 inch in diameter in the side of the fence post opposite from the gate framing, and where the throw when extended from the deadbolt lock is aligned to 1) fit into a hole existing in a spring operated gate latch to prevent the gate latch from opening when the throw is extended through the hole in the latch by use of a key or thumb turn or other means, or 2) fit into a hole in a throw receiver, or 3) fit over/under the handle of a gate latch, thereby rendering a fence gate that can be locked and unlocked from each side of the gate, with preferably at least one side being lockable using a key.

The invented lock apparatus will be made of moldable materials such as plastics and metals and will use commonly available deadbolt locks snugly fitted together with other parts of the invented apparatus to form the invention and a system to use available standard deadbolt locks to lock and unlock fence gates.

This invention addresses the need for a key operated vinyl fence gate lock easy installable by homeowners of ordinary skills that uses commonly available deadbolt locks.

### BACKGROUND OF THE INVENTION

Field of Invention

The field of art of the invention is locking mechanisms for gates for vinyl fencing. The field of art encompasses the following classes and subclasses: 70/56, 129, 417, 421, 451, 93, 134, 139, and 292/337.

The invention, DEADBOLT VINYL GATE FENCE LOCK AND SYSTEM, is an apparatus of joined parts that allows the locking of a gate framed in vinyl parts to a stationary post made of vinyl. The stationary vinyl post is typically hollow with the walls of the post being typically of a thickness of no more than ⅜ of an inch and the outer diameter of the gate framing and post typically ranging from 3½ inches by 3½ inches square to 5 inches by 5 inches square in size. Sometimes the inside walls of the fence posts are lined with a metal sleeve for strength but the interior remains hollow. The gate's framing is typically made of vinyl framing members that have an outer thickness from 1 inch to 5 inches. The gate frames are also typically hollow inside the walls of the framing members with the walls of the gate framing being typically of a thickness of approximately 1/8 of an inch. Sometimes the inside walls of the gate framing are lined with joined metal sleeves for strength. The gate framing is connected to a second stationary fence post with hinges. The invented lock can be mounted to either a gate frame or to a fence post dependent upon thickness of each, however, the preferred installation calls for the deadbolt lock and cup or cups to be installed in the stationary fence post that does not have hinges.

The gate and fencing is made of vinyl materials as vinyl materials are not subject to damage by termites, insects and/or water damage as is wood fencing materials and are color fast.

The invented lock apparatus will be made of moldable materials such as plastics and metals and will use commonly available deadbolt locks snugly fitted together with other invented apparatus to form the invention and a system to use available deadbolt locks to lock and unlock fence gates.

This invention addresses the need for a key operated vinyl fence gate lock easy installable by homeowners of ordinary skills that uses commonly available deadbolt locks.

### Prior Art

Preliminary research of patents issued did not identify the existence of any prior art that incorporates all of the conjoined components of this invention. Prior art identified as relevant are listed below.

| | | | |
|---|---|---|---|
| 4,565,079 | Robert J. Smith | Gate Lock | Jan. 21, 1986 |
| 5,024,473 | Donald E. McQuade | Gate Lock | Jun. 18, 1991 |
| 5,103,658 | Donald E. McQuade | Gate Latch | Apr. 14, 1992 |
| 5,257,519 | J. Claton Miller, III | Gate Lock | Nov. 2, 1993 |
| 5,588,314 | Anthony D. Knezovich | Gate Lock | Dec. 31, 1996 |
| 5,765,411 | William Rowan | Fence Lock | Jun. 16, 1998 |
| 6,192,723 | Richard G. Brownell, Sr. | Gate Lock | Feb. 27, 2001 |
| 6,227,019 | Kn Singh Chhatwal | Gate Lock | May 8, 2001 |

U.S. Pat. No. 4,565,079 discloses a deadbolt on a gate.

U.S. Pat. No. 5,024,473 discloses using a deadbolt to prevent a gate latch from being moved.

U.S. Pat. No. 5,103,658 discloses a deadbolt in combination with a grate that extends to prevent the fork latch form moving. (See lock plug shafts 146, 148 in FIGS. 5-7.)

No prior art was found that addressed the existing need to lock and unlock a vinyl gate from both sides of the gate in the manner addressed by the invented keyed lock apparatus described herein. Further, there was no lock mechanism found in research of lock manufacturers sales catalogues and telephone contacts with lock manufacturers and sales outlets that was designed and sized to solve the operational and installation specifications of the invented gate lock apparatus described herein.

Moreover, in the patent search for this application, no other prior art was identified which singularly incorporated all the specific improvements and engineering design specified herein for the intended purpose of the invention i.e. to provide a practical system of components that can be easily installed (and removed if necessary) by individuals of the general public, contractors, and others with limited skills, that makes it possible to fabricate a gate having framing members from 1 inch to 5 inches thick in combination with a stationary fence post that can be from 31/2 inches square to 5 inches square that are made of vinyl, that can be locked and unlocked from both sides of the gate using a keyed standard house deadbolt lock.

Analysis of the invented structure and design of the prior art uncovered the following facts:

1. Although some parts of the design of the invented system have been in existence in the cited prior art for a great number of years, individuals expert and particularly knowledgeable in the field of designing and manufacturing locks for gates for fencing have not produced or designed a gate locking and unlocking apparatus to address the purpose of the design of the invented system, therefore, it can be stated that the subject matter of this application is not obvious to a person of ordinary skill in the art if those individuals who are expert in the art have not conceived the subject system described herein.

2. Although prior art has some of the related segments of the invention none singularly have overcome their deficiencies of size, parts, and/or assembly that are solved by the invented apparatus.

Specifically, prior art does not provide for a comprehensive conjoined component solution to the problems of providing a practical and decoratively finished gate lock system that is easy to install in vinyl fence posts that are typically 4 inch by 4 inch or 5 inch by 5 inch square and hollow.

### SUMMARY OF THE INVENTION

The field of art of the invention is locking mechanisms for gates for vinyl fencing The invention is preferably the combination of a standard deadbolt lock, cup or cups, used in combination with a standoff receiver with a hole or a gate latch with a hole aligned to receive the throw of a standard deadbolt lock with said deadbolt lock preferably being operable on one or both sides using a key; said apparatus is intended for use in stationary fence posts to affix gates that are framed of hollow vinyl members that are 1 inch to 5 inches thick.

The invention is a deadbolt lock installable with a cup or cups to utilize a latch apparatus or deadbolt lock throw receiver and system that can be operable on one or both sides using a key or other means with said apparatus that is intended for use in stationary fence posts or in gates that are framed of hollow vinyl members that are typically hollow and 4 inches by 4 inches or 5 inches by 5 inches in diameter.

The invented apparatus is an assembly of unique and commonly available parts designed to be put together in the hollow vinyl gate post and adjacent vinyl gate framing to provide a means of connecting the post and framing with a device that can be locked and unlocked from each side of the gate, with at least one side being lockable using a key or other means.

The device will be made of plastics and/or metal parts sized and designed to affix one to another to form the complete lock. The invention may have alternate embodiments that will accomplish the same purpose—to lock or unlock a fence gate from ether side of a gate by use of a keyed tumbler or a thumb turn to extend or retract the throw of a deadbolt lock mechanism in an internal or external hole.

A kit includes a deadbolt lock commonly sold for installation in home entry doors, a cup or cups to provide a means to install the deadbolt lock; a throw or throw receiver or a spring operated latch commonly sold to affix fence gates to fence posts, the latch possibly having a hole to receive the throw of the deadbolt mechanism, instructions to indicate where holes must be cut in 4 inch by 4 inch or 5 inch by 5 inch gate or fence framing, and instructions for installing the lock mechanism.

### BACKGROUND OF INVENTION

Individuals who purchase vinyl fencing must fabricate an individual special lock or use a padlock and apparatus to lock a gate in vinyl fencing on one side of the fencing.

Commonly available home deadbolts locks do not fit the width of 4 inch and 5 inch square hollow fence parts as they are made to fit 1 14 inch to 1¾ inch wide standard house doors.

The invented gate lock has been devised to provide preferably a key operated lock that can be locked and unlocked on both sides of a vinyl fence gate combined with an operable spring latching mechanism. The invented gate lock renders the latch mechanism inoperable by use of a key and/or a thumb turn thereby locking a gate in place.

The invented gate latch lock is based upon making adaptations to existing parts and possibilities in combinations not obvious to persons of skill in fence lock systems.

The inventors noted that standard deadbolt locks fit into doors from 1¼ inches thick to doors 1¾ inches thick (i.e. a 1/2 inch expansion capability).

To accommodate the installation of standard deadbolt locks in hollow 5″×5″ and 4″×4″ square vinyl posts, the inventors fabricated cups sized to fit into holes in each side of said vinyl posts sized to reduce the distance between the backs of the cups to the 1¼ inch to 1¾ inch spacing required to install standard deadlock locks and to also align the throw coming from an installed deadbolt lock with a hole in a gate latch or a hole in a throw receiver wherein the extended throw in the latch's hole will render the latch inoperable or catch in the hole of the throw receiver.

At the time of submission of prior provisional patents and disclosures there was no key lock apparatus that used a standard door deadbolt lock such as the lock made for the Kwickset division of the Black and Decker Corporation that could be readily installed into the 4 and 5 inch square hollow parts used to make vinyl fence posts.

### ADVANTAGES OF THE INVENTION

The advantages of the invention differing from prior art are that:

1. The invented apparatus is designed to use a cup or 2 cups sized to allow the installation of standard deadbolt locks into the width (e.g. typically 4 inches by 4 inches and 5 inches by 5 inches square) of hollow vinyl fence posts and gate framing used for vinyl fencing.

2. The invented apparatus incorporates the use of commonly available double and single deadbolts thereby saving the tooling of the key operated deadbolt and also making the changing and keying of the deadbolt locks universal throughout the United States.

3. The invented apparatus incorporates the use of a gate latch with a hole to lock a gate.

4. The invented apparatus incorporates the use of a standoff receiver with a hole to lock a gate.

5. The invented apparatus makes it possible to have a vinyl fence gate that is lockable using a key either on one side or on both sides of the gate

6. The invented apparatus makes it possible to use the same key to open a house door and a fence gate.

7. Installation of the invented apparatus requires no special tools.

8. The invented apparatus is designed to be easily installed and removed by persons of ordinary skills.

9. The invented apparatus gives the general public and contractors an option that does not presently exist that is to install a prefabricated keyed lock apparatus in vinyl fence gates that can operable from both sides of a gate using a key or configured to be key operable from one side and optionally thumb turn operable from the other side of the gate.

10. The invented apparatus preferably uses a cup or a pair of cups to facilitate the mounting of a standard home door deadbolt mechanism.

11. The invented apparatus can be installed in a one cup embodiment on a standard wood fence gate to lock fence gates made of wood.

12. The invented apparatus can be installed in a one cup embodiment on a hollow vinyl fence post or gate frame typically 4 inches by 4 inches to 5 inches by 5 inches square to allow the installation of a standard deadbolt lock to lock fence gates.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 shows a front view of a shallow cup installed in a vinyl post with the deadbolt lock face plate assembly and throw of a deadbolt lock showing.

FIG. 2 shows a profile view of a latch with hole.

FIG. 3 shows the latch with hole installed on the vinyl post over the throw of the deadbolt lock.

FIG. 4 shows the typical profile of the shallow and deep cups having a lip and having an opening in the rear of the cup.

FIG. 5A shows the cutaway side view of the preferred depth of the shallow cup.

FIG. 5B shows the cutaway side view of the preferred depth of the deep cup and the preferred diameter of the shallow and deep cups.

FIG. 6 shows a profile view of an assembled deadbolt lock that is commonly available from such vendors as the Kwickset Corporation.

FIG. 7 shows a side cutaway profile view of selected components of the invented gate lock as a profile of the shallow cup when installed on the wall of a vinyl post.

FIG. 8 shows a top cutaway profile view of select components of the invented gate lock where the top cutaway profile of a cup is shown installed into the walls of the vinyl post.

FIG. 9 shows an exploded side view of the parts of the invented gate lock with a latch with hole.

FIG. 10 shows a profile view of the proper preparation of a fence post where cup holes and a cylinder hole have been marked and drilled on opposite sides of the fence post.

FIG. 11 shows a profile view of a fence post where shallow cups and the deadbolt cylinder face plate have been installed and the deadbolt lock face plate assemblies have been aligned to be installed.

FIG. 12 shows a profile view of an assembled lock parts with the latch with hole installed aligned with the latch with hole.

FIG. 13A shows steps 1 to Step 5 of the instructions for installing the invented gate lock with a latch with a hole.

FIG. 13B shows steps 6 to Step 10 of the instructions for installing the invented gate lock with a latch with a hole.

FIG. 14 shows a rear view of a vinyl post with a shallow cup with the deadbolt lock face plate assembly and throw of the deadbolt showing.

FIG. 15 shows a rear profile view of a standoff receiver.

FIG. 16 shows a rear view of a vinyl post and the standoff receiver aligned with the throw of the deadbolt lock.

FIG. 17 shows a top view of the preferred measurements of the vinyl post with a standoff receiver.

FIG. 18 shows a front profile view of the preferred measurements of the standoff receiver.

FIG. 19 shows preferred size measurements of a front view of the deadbolt cylinder face plate.

FIG. 20 shows preferred size measurements of the face plate gasket.

FIG. 21 shows the deadbolt cylinder face plate installed in the face plate gasket.

FIG. 22 shows a side view of the profile of the recessed rim of the face plate gasket.

FIG. 23 shows a side view of the preferred measurements of an oval throw receiver.

FIG. 24 shows a front view of the oval throw receiver.

FIG. 25A shows Step 1 to Step 4 of typical installation instructions for the embodiment of the invented lock that uses a standoff receiver as a means to affix a gate to an opposing fence post.

FIG. 25B shows Step 5 to Step 9 of typical installation instructions for the embodiment of the invented lock that uses a standoff receiver as a means to affix a gate to an opposing fence post.

FIG. 26 shows a profile view of an extra deep cup having a lip.

FIG. 27 shows a side view of the position of the extra deep cup installed in a vinyl post along with deadbolt face plate assemblies.

FIG. 28 shows a side view of the latch without hole.

FIG. 29 shows the latch without hole and extra deep cup installed on a vinyl post.

FIG. 30 shows the preferred measurements of a circularly shaped wood gate cup.

FIG. 31 shows a rear view of gate frame boards with a deadbolt lock hole.

FIG. 32 shows a side view of a wood gate cup that will be inserted into a fence board hole that is on center with a deadbolt lock hole.

FIG. 33 shows a side view of parts of the invented wood gate lock.

FIG. 34 shows the typical installation instructions for the invented wood gate lock.

### DESCRIPTION OF INVENTION

The invented apparatus includes a kit where cups (e.g. approximately 3¼ inches in diameter) that have overlapping top flanges of at least 1/8 inches wide are inserted into and fit snugly in holes drilled into the sides of a hollow vinyl fence post with the top flange of each cup (i.e. lip of the cup) overlapping and preventing the cups from being drawn through the holes; said cups being deep enough to accept the installation of standard home deadbolt lock mechanisms that are designed to be installed on 1¼ inch to 1⅞ inch thick doors, and where the deadbolt lock throw is installed to extend through a parallel hole of approximately 1 inch in diameter in the side of the fence post opposite from the gate framing, and where the throw when extended from the deadbolt lock is aligned to 1) fit into a hole existing in a spring operated gate latch to prevent the gate latch from opening when the throw is extended through the hole in the latch by use of a key or thumb turn, or 2) fit into a hole in a throw receiver, or 3) over/under the handle of a gate latch, thereby rendering a fence gate that can be locked and unlocked from each side of the gate, with preferably at least one side being lockable using a key.

Components of the Invention

The components of the preferred embodiment of the invention include preferably:

1. Deadbolt Lock

A double or single cylinder lock, operable with a key, commonly manufactured by companies such as the Kwickset Division of the Black and Decker Corporation, designed and sized to be installed into the exterior doors of houses; said deadbolt locks are sold at hardware stores and chain stores such as Home Depot, Inc. and Lowes Home Improvements, Inc.; further said locks having a cylinder containing a throw that can be extended and retracted herein referred to as the throw of the deadbolt lock.

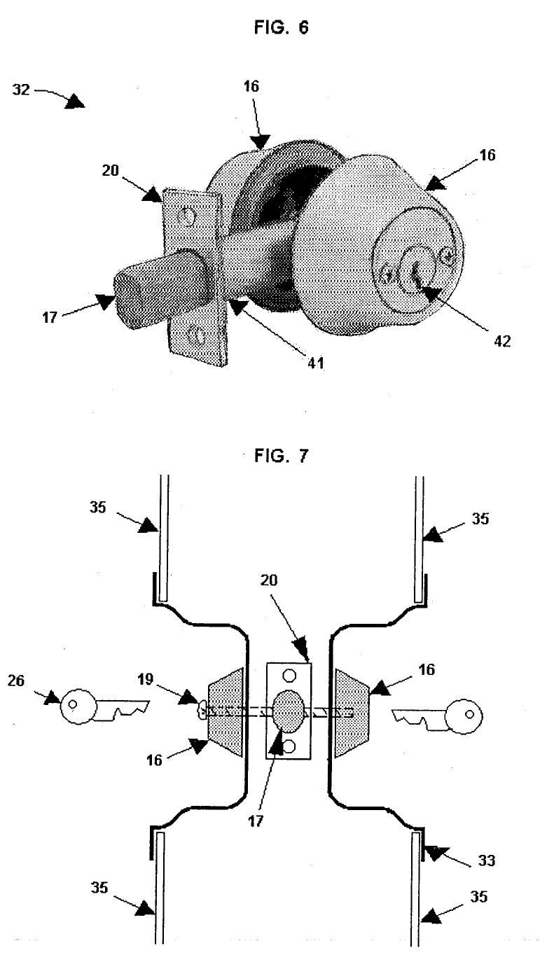

See FIG. 6.

2. Deep Cup.

A round (or square or rectangular) flanged cup approximately 2¼ inches deep outside diameter and sized to fit in a hole approximately 3¼ inches in diameter to reduce the distance to an outside edge of a post to allow the normal installation of a deadbolt lock in a 5 inch square post when matched with a shallow cup. See FIGS. 4 and 5B.

3,. Shallow Cup.

A round (or square or rectangular) flanged cup approximately 1¼ inches deep outside diameter and sized to fit in a hole approximately 3¼ inches in diameter to reduce the distance to an outside edge of a 4 inch by 4 inch square post to allow the normal installation of a deadbolt lock in a 4 inch when 2 shallow cups are installed or for a 5 inch square post when 1 shallow cup and 1 moderately deep cup are installed. See FIGS. 4 and 5A.

4. Extra Deep Cup.

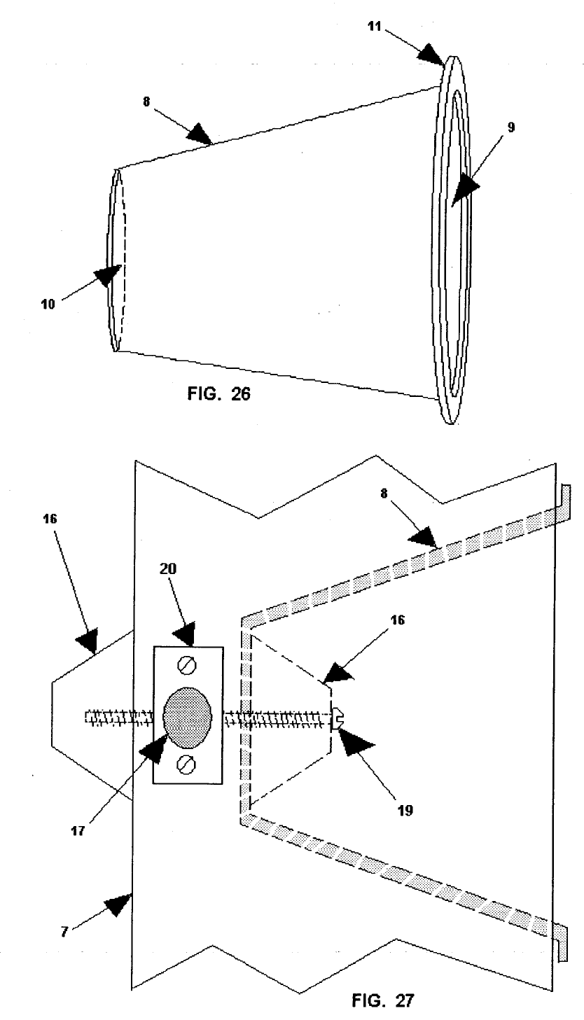

A round (or square or rectangular) flanged cup preferably approximately 3½ inches deep sized outside diameter and sized to fit into a larger hole such as 4¼ inches in diameter to reduce the distance to an outside edge of a post to allow the normal installation of a deadbolt lock in a 5 inch square post. See FIGS. 26, 27, 28, and 29.

5. Gate Latch With Hole.

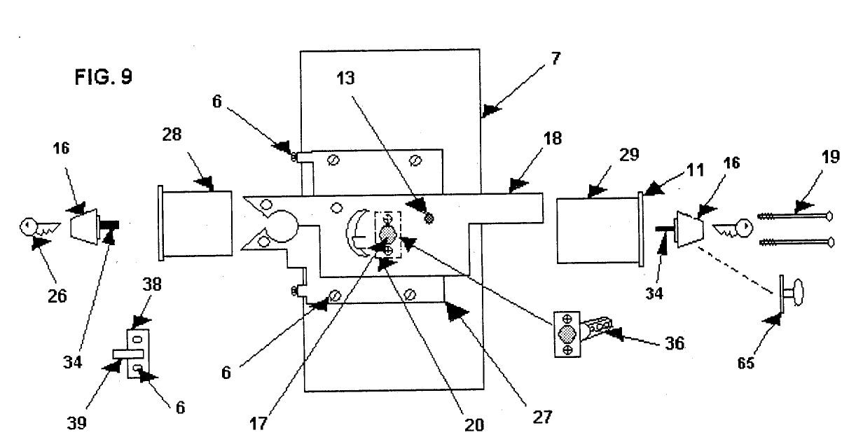

A side mounted spring operable gate latch with a hole sized to fit and receive the deadbolt lock's throw. See FIGS. 2 and 9.

6. Standoff Receiver

A plate with a hole sized to receive a throw coming from a deadbolt lock; said plate with screw holes aligned in the first 1½″ of width to allow the plate to be fasten to gate frames as small as 1½ inch thick with the hole in the plate being always at the same distance from the front edge of the gate frame to align with the deadbolt lock throw, and further, said hole being oval in shape to allow for minor settling of a gate due to subsidence in soils. See FIGS. 15, 16, 17, and 18.

7. Oval Receiver

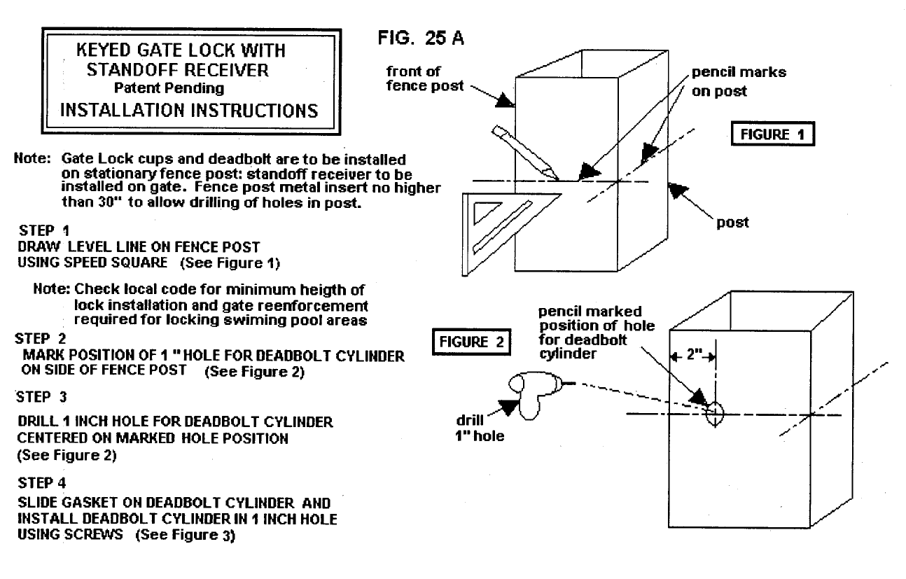

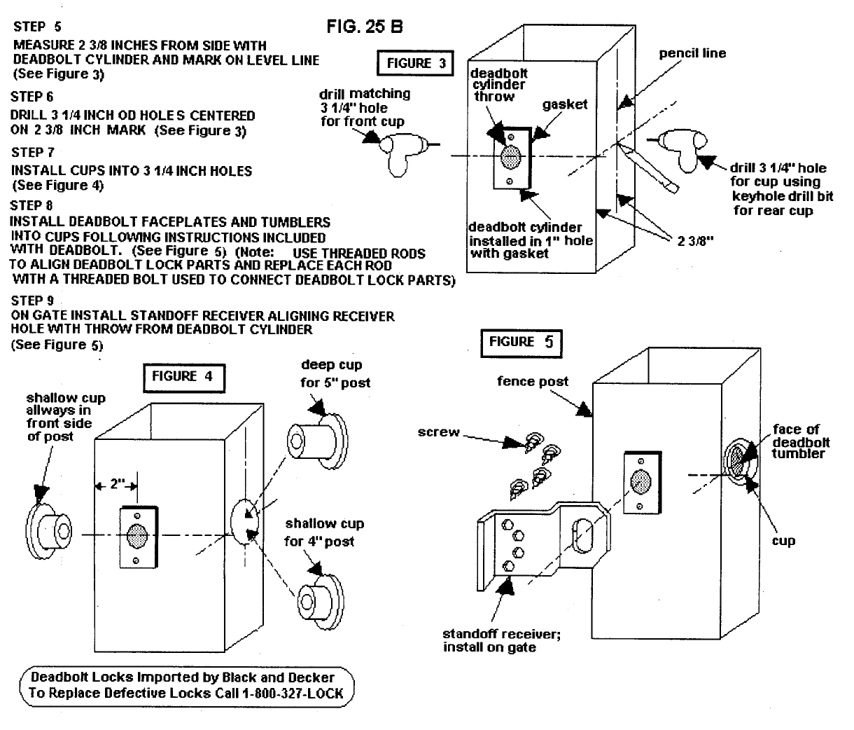

A receiver with a hole that is oval in shape sized to receive the throw of a deadbolt lock that is affixed to the opposing gate frame to physically affix a fence post to a gate frame. See FIGS. 23 and 24.

8. Throw Gasket

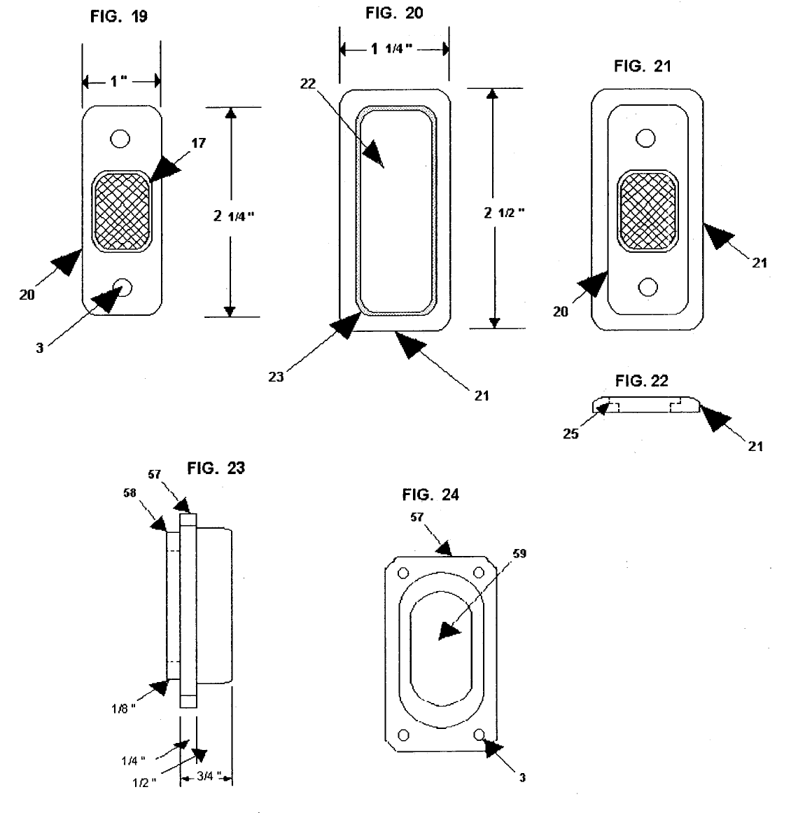

A bushing with an inset flange designed with a hole sized to cover the edges of the face plate of the throw of a standard deadbolt lock to provide for the faceplate being away from the face of a post. See FIGS. 19, 20, 21, and 22.

9. Wood Fence Gate Cup.

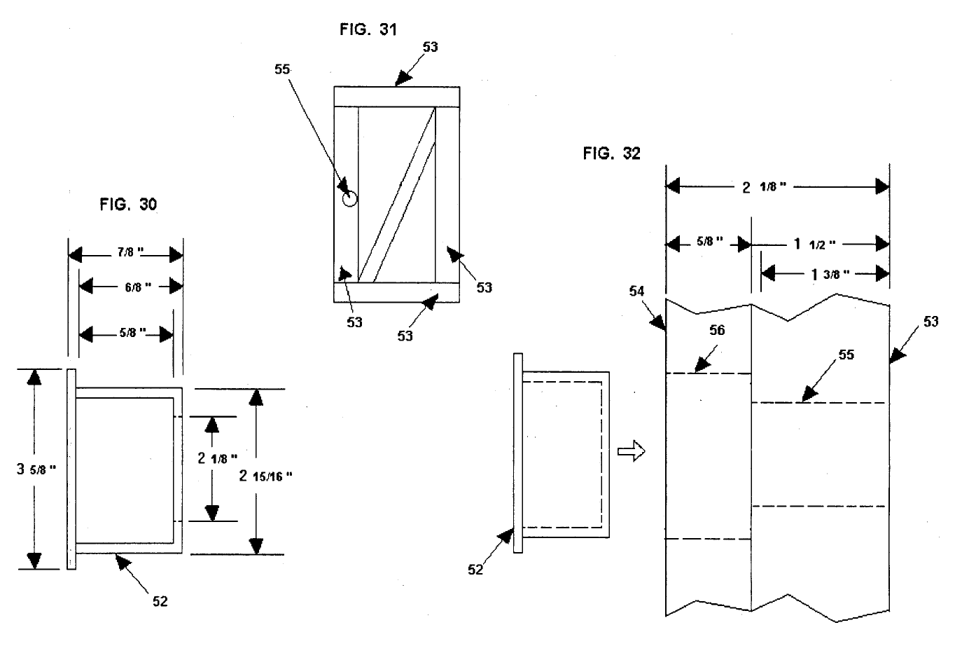

A flanged cup approximately 3/4 inches deep outside diameter and sized to fit in a hole approximately 3 inches in diameter to reduce the distance to an outside edge of a post to allow the normal installation of a deadbolt lock in the combined width of a wood fence board attached to fence gate framing; said combination being of approximately 2⅛ inches thick. See FIGS. 30, 31, 32, and 33.

10. Installation Instructions

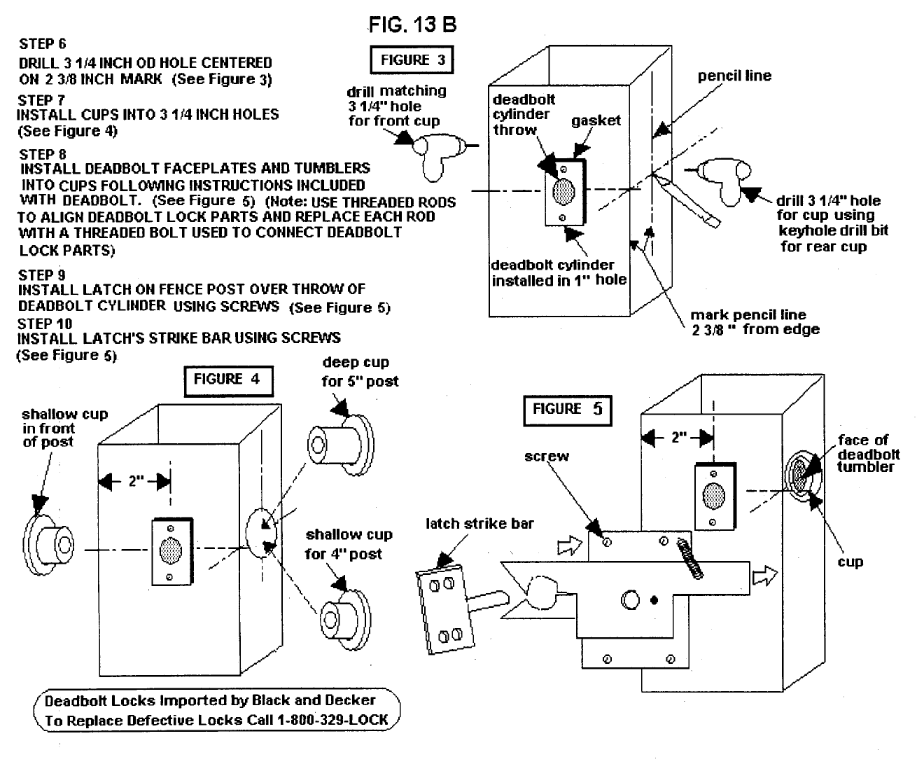

Instructions detailing the steps to install the invented lock and latch parts. See FIGS. 13A, 13B, 25A, and 25B.

11. Kit Packaging

A box or bag containing all of the above parts and optionally two threaded rods of the same thread size as the threaded deadbolt lock bolt (e.g. typically 8/32 threaded rods) to facilitate the installing the deadbolt lock into the cups or cup.

Embodiments of the Invention.

The preferred embodiments of the invention were determined as described below.

Two Cups Embodiments

Typical Purpose: For New Vinyl Fence Gates Without Installed Latches

Embodiment 1.

A kit containing, a standard deadbolt lock, 2 cups and a gate latch with a hole aligned to receive the throw of the deadbolt lock

Typical Purpose: For Existing Vinyl Fence Gates With Installed Latches

Embodiment 2

A kit containing a standard deadbolt lock, 2 cups, and a standoff receiver with a hole aligned to receive the throw of the deadbolt lock and optionally a throw gasket to provide a finished appearance to the exposed deadbolt cylinder face plate.

This is not to say that the preferred embodiments are the only way to combine components of the invention or the only combination of components that will achieve the intent of the invention (i.e. to be able to use a standard deadbolt lock to lock and unlock a fence gate from one or both sides). For example one cup embodiments can be made using the parts of the invention such as:

Embodiment 3.

A kit containing a standard deadbolt lock, a single cup to fit a deadbolt lock into a wood fence gate, and optionally but not necessarily having an oval receiver to receive the throw of the deadbolt lock.

Embodiment 4.

A kit containing a standard deadbolt lock and a single cup to fit a deadbolt lock into hollow vinyl fence posts being optionally used with a gate latch without a hole or an oval receiver or other device to receive the throw of a deadbolt lock.

It is to say that the preferred embodiments appear to be the more logical and easily installed combination of parts that will make it possible to lock fence gates of different thickness (e.g. 2 inches, 3 inches, 3¾ inches, 4 inches, 4¾ inches and 5 inches) with fence posts ranging from 3¾ inches to 5 inches square using one of the preferred embodiments of the lock kit.

It is also to say that although the combination of parts being included in the lock kit provides the parts to fit all possible current combinations of common sizes of vinyl fence materials, market demands and price sensitivities may dictate that including all parts in the lock kit is not cost effective or desired by purchasers as other parts of the invention are readily available such as standard deadbolt locks and gate latches that can be affixed in a closed position by extension of the throw of the deadbolt lock.

Main Embodiments.

Two Cups Embodiment.

The preferred embodiment of the invention employs two cups as shown on FIGS. 1, 3, 7, 8, 9, 10, 11, 12, 13A, 13B, 14, 16, 25A and 25B to install a deadbolt lock shown on FIG. 6 wherein the throw of the deadbolt lock inserts into a hole in either:

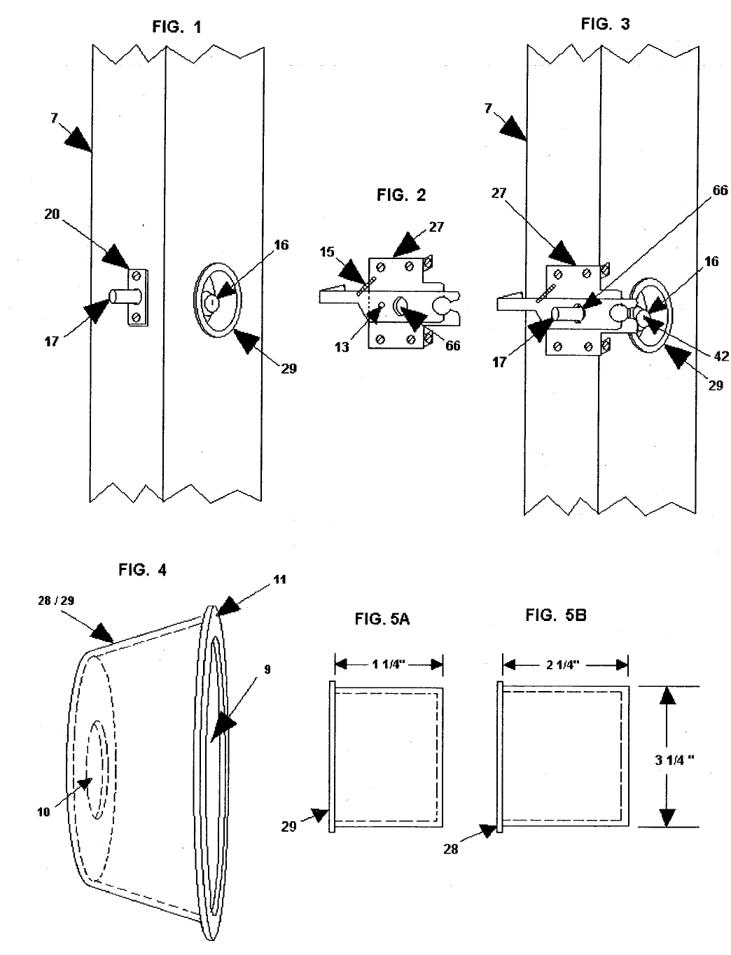

1. A gate latch as shown on FIGS. 3 and 13B, or over the gate latch if the gate latch is mounted upside down, or

2. A hole in a standoff receiver as shown on FIGS. 16, and 25B, or

3. A hole in an oval receiver such as that shown on FIGS. 23 and 24.

Single Cup Embodiment.

The second preferred embodiment of the invention employs a single cup for installation of a deadbolt lock as shown on FIGS. 26, 27, 28, and 29 wherein the throw of the deadbolt lock:

1. Extends and retracts under a gate latch as shown on FIGS. 29 or over the gate latch it the gate latch is mounted upside down, or

2. Inserts into a hole in an oval receiver such as that shown on FIGS. 23 and 24.

Installation of the 2 Cup Embodiment of the Invention in a Post.

The first preferred embodiment of the invention (i.e. with two round cups) will be installed into a stationary fence post opposite a fence gate with a jaws latch with a hole as shown on FIGS. 3, 13A and 13B, or into a stationary fence post opposite a fence gate with a standoff receiver as shown on FIGS. 16, 25A, and 25B.

Description of Embodiments

Preferred Embodiment Using Round Cups. This embodiment is exemplified on FIGS. 1, 2, 3, 9, 16, 26, and 27 wherein round cups are used to install standard deadbolt locks into the round holes cut in a fence post; with the deadbolt lock face plate assemblies being attached to one another by use of threaded bolts to firmly hold the cups, deadbolt lock face plate assemblies in place allowing a deadbolt cylinder to be key operated to extend or retract the throw of the deadbolt lock through a hole in a gate latch or a hole in a standoff or oval receiver.

Parts of Invention Shown on Drawings.

1. Standoff Receiver

2. Center of Throw Hole

3. Screw Hole

4. Standoff Receiver Throw Hole

6. Screw

7. Vinyl Post

8. Extra Deep Cup

9. Opening in Front of Cup

10. Opening in Rear of Cup

11. Lip of Cup

12. Latch Without Hole

13. Latch Focrum

14. Latch Jaws

15. Latch Spring

16. Deadbolt Lock Face Plate Assembly

17. Throw of Deadbolt Lock

18. Handle of Latch

19. Threaded Deadbolt Lock Bolt

20. Deadbolt Cylinder Face Plate

21. Face Plate Gasket

22. Hole in Face Plate Gasket

23. Recessed Rim of Gasket

24. Assembled Face Plate and Gasket

25. Profile of Recessed Rim of Gasket

26. Key to Operate Deadbolt Latch

27. Latch with Hole

28. Deep Cup of 2 Cup Embodiment

29. Shallow Cup of 2 Cup Embodiment

30. 5 Inch by 5 Inch Vinyl Post

31. 4 Inch by 4 Inch Vinyl Post

32. Deadbolt Lock

33. Cutaway Profile of Cup

34. Tumbler Protrusion

35. Wall of Vinyl Post

36. Deadbolt Lock Cylinder

37. Position of Throw Through Hole in Latch

38. Latch Strike Bar Assembly

39. Latch Strike Bar

40. Latch Flange

41. Deadbolt Cylinder

42. Key Slot

43. Throw Operation Hole in Cylinder

44. Hole for Threaded Deadbolt Lock Bolt

45. Cylinder Hole

46. Cup Hole

47. Level

52. Wood Gate Cup

53. Gate Frame Board

54. Fence Board

55. Deadbolt Lock Hole

56. Fence Board Hole

57. Oval Throw Receiver

58. Oval Receiver Flange

59. Oval Receiver Throw Hole

65. Thumb Turn

66. Latch Hole

### DETAILED DESCRIPTION OF THE DRAWINGS

FIG. 1 shows a front view of a vinyl post 7 with the shallow cup 29 installed in a vinyl post 7 with the deadbolt lock face plate assembly 16 of an installed deadbolt lock showing in the shallow cup 29 and a throw of a deadbolt lock 17 extending from the center of the deadbolt cylinder face plate 20 and is intended for use with FIG. 3 to explain the use and installation of a latch with hole.

FIG. 2 shows a latch with hole 27 where a latch spring 15 aligns the latch hole 66 when pivoted by a latch focrum 13 and is intended for use with FIG. 3 to explain the use and installation of the latch with hole 27.

FIG. 3 shows the latch with hole 27 installed on the vinyl post 7 where the throw of the deadbolt lock 17 is extended through the latch hole 66 by use of a key inserted in the key slot 42 in the deadbolt lock face plate assembly 16; with said Deadbolt Lock Face Plate Assembly being installed in a shallow cup 29.

FIG. 4 shows the design of the shallow cup 29 and the deep cup 28 having a opening in the rear of the cup 10 and an opening in the front of the cup 9 with the cups having a lip 11 to stop the cups from being pulled through the vinyl post.

FIG. 5A shows the cutaway side view of the preferred depth of the shallow cup 29.

FIG. 5B shows the cutaway side view of the preferred depth of the deep cup 28 as well as the preferred diameter of the shallow cup and the deep cup.

FIG. 6 shows a profile view of an assembled deadbolt lock 32 that is commonly available from such vendors as the Kwickset Corporation having a deadbolt lock face plate assembly 16 with a key slot 42 and a deadbolt lock cylinder 41 where from a throw of the deadbolt lock 17 is shown as retracted into the deadbolt lock cylinder 41 through the deadbolt cylinder face plate 20 whereas said throw can be extended out of the deadbolt lock cylinder 41 through the deadbolt cylinder face plate 20 by the turning of an appropriate key in the key slot 42.

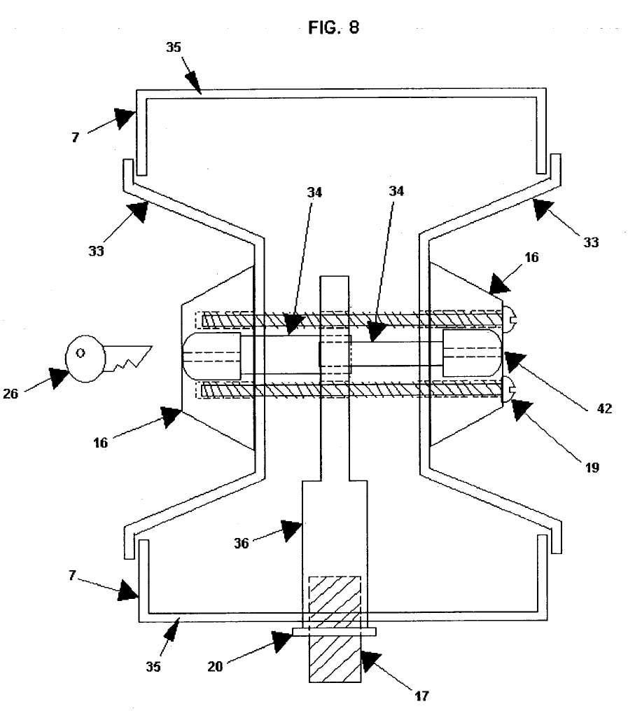

FIG. 7 shows a side cutaway profile view of selected components of the invented gate lock as a profile of the shallow cup 33 when installed on the wall of a vinyl post 35 being held in place by a threaded deadbolt lock bolt 19 joining the opposing deadbolt lock face plate assemblies 16 and showing also the location of the deadbolt cylinder face plate 20 and the throw of the deadbolt lock 17 and indicating a key to operate the deadbolt lock 26.

FIG. 8 shows a top cutaway profile view of select components of the invented gate lock installed in a vinyl post 7 where the top cutaway profile of a cup 33 is shown installed into the walls of the vinyl post 35 with the deadbolt lock face plate assemblies 16 is held in pace by a threaded deadbolt lock bolt 19 with the tumbler protrusions 34 being nested together to make the deadbolt throw 17 that is in the deadbolt lock cylinder 36 made operable by a key 26 inserted into the key slot 42 of the deadbolt lock face plate assemblies 16.

FIG. 9 shows an exploded side view of the parts of the invented gate lock where a vinyl post 7 that has been prepared by the drilling of holes at appropriate places can receive the shallow cup 29 and deep cup 28, both having lips 11 and deadbolt lock face plate assemblies 16 with tumbler protrusions 34 and a latch with hole 27 aligned with the deadbolt lock cylinder 36 with the latch being affixed with screws 6 and made operable by use of the handle of the latch 18 and with the deadbolt face plate assemblies 16 being held together by threaded deadbolt lock bolts 19 so that the deadbolt throw 17 can be extended and retracted through the latch with hole 27 by use of a key 26 or optionally a thumb turn 65.

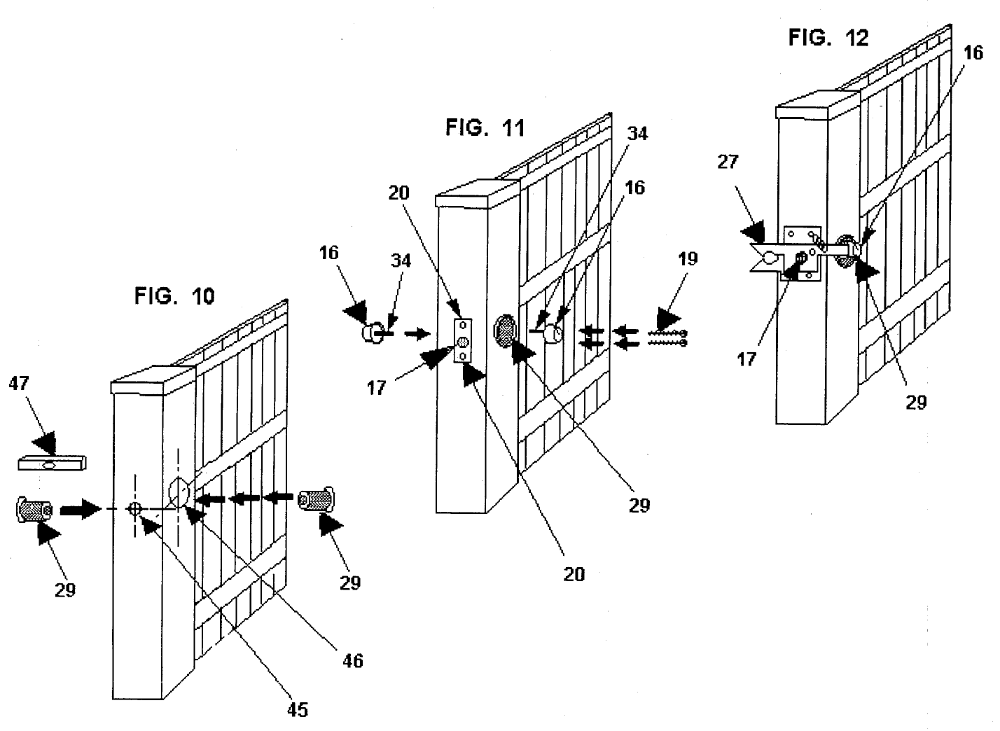

FIG. 10 shows a profile view of the proper preparation of a fence post where cup holes 46 have been marked using a level 47 and drilled on opposite sides of the fence post and a cylinder hole 45 has been drilled on the right angle side of the vinyl post to make possible the installation of shallow cups 29 into the vinyl post.

FIG. 11 shows a profile view of a fence post where shallow cups 29 and the deadbolt cylinder face plate 20 have been installed and the deadbolt lock face plate assemblies 16 with tumbler protrusions 34 have been aligned to be installed into the shallow cups 29 and affixed using the threaded deadbolt lock bolt 19.

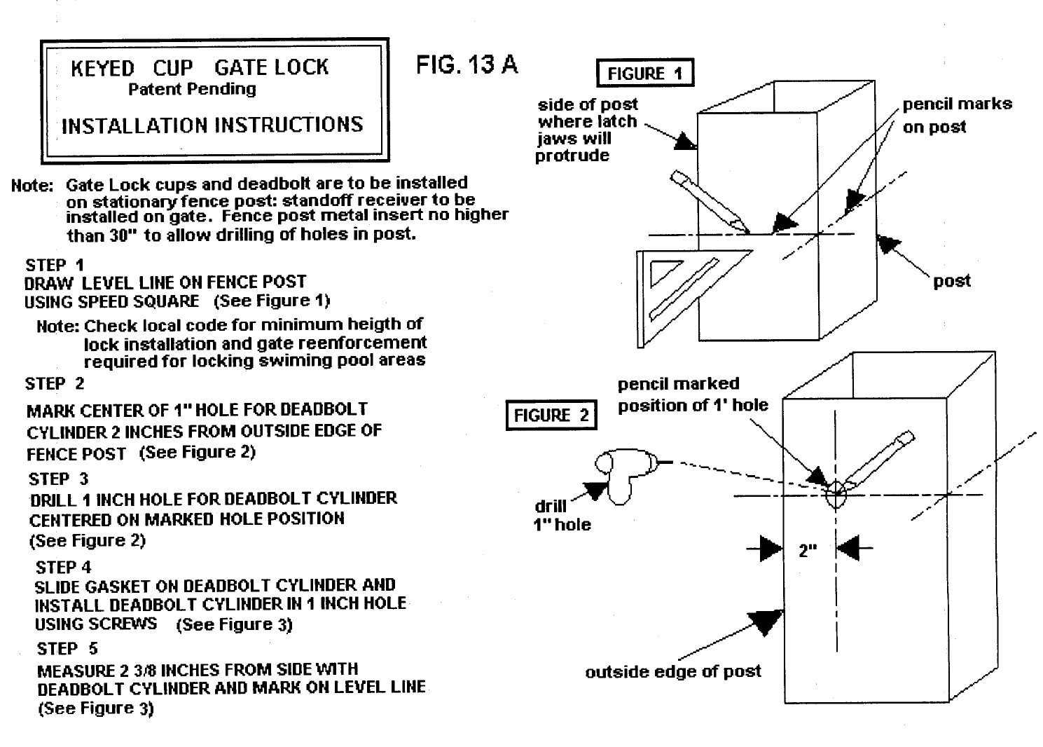

FIG. 12 shows a profile view of an assembled lock parts where the latch with hole 27 has been aligned with the shallow cups 29 and installed so that the throw of the deadbolt lock 17 can be extended through the latch with hole 27.

FIG. 13A shows steps 1 to Step 5 of the instructions for installing the invented gate lock with a latch with a hole.

FIG. 13B shows steps 6 to Step 10 of the instructions for installing the invented gate lock with a latch with a hole.

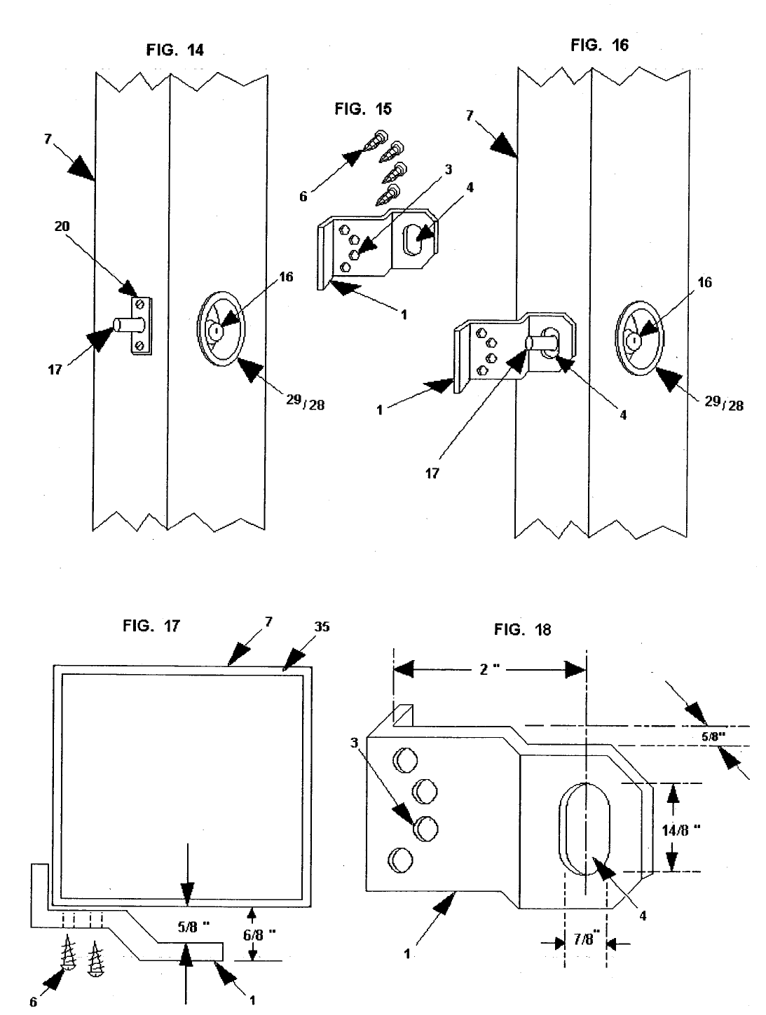

FIG. 14 shows a rear view of a vinyl post 7 and a shallow cup 29 installed in the vinyl post 7 with the deadbolt lock face plate assembly 16 of an installed deadbolt lock showing in a shallow cup 29 or deep cup 28 and a deadbolt throw 17 extending from the center of the deadbolt cylinder face plate 20 and is intended for use with FIG. 21 to explain the use and installation of a standoff receiver.

FIG. 15 shows a rear profile view of a standoff receiver 1 that has a standoff receiver throw hole 4 to be aligned with a deadbolt lock throw and to be fastened to an opposing vinyl post with screws 6 going through screw holes 3 and is intended for use with FIG. 21 to explain the use and installation of a standoff receiver 1.

FIG. 16 shows a rear view of a vinyl post 7 and the standoff receiver 1 with the standoff receiver throw hole 4 over the deadbolt lock throw 17 that extends from the side of the vinyl post 7 and showing a shallow cup 29 or deep cup 28 and a Deadbolt Lock Face Plate Assembly 16 in the installed cup.

FIG. 17 shows a top view of the preferred measurements of the combination of a vinyl post 7 with a standoff receiver 1 to be held in place by screws 6 penetrating the wall of the vinyl post 35.

FIG. 18 shows a front profile view of the preferred measurements of the standoff receiver 1 having screw holes 3 and having a standoff receiver throw hole 4.

FIG. 19 shows preferred size measurements of a front view of the deadbolt cylinder face plate 20 with screw holes 3 and showing the surface of the deadbolt lock throw 17.

FIG. 20 shows preferred size measurements of the face plate gasket 21 having a recessed rim of the gasket 23 and a hole in the face plate gasket 22.

FIG. 21 shows the deadbolt cylinder face plate 20 installed in the face plate gasket 21.

FIG. 22 shows a side view of the profile of the recessed rim 25 of the face plate gasket 21.

FIG. 23 shows a side view of the preferred measurements of an oval throw receiver 57 that could be used in place of a standoff receiver with said oval throw receiver possibly having a oval receiver flange 58.

FIG. 24 shows a front view of the oval throw receiver 57 with screw holes 3 and an oval receiver throw hole 59 in the center of said oval throw receiver.

FIG. 25A shows Step 1 to Step 4 of typical installation instructions for the embodiment of the invented lock that uses a standoff receiver as a means to affix a gate to an opposing fence post.

FIG. 25B shows Step 5 to Step 9 of typical installation instructions for the embodiment of the invented lock that uses a standoff receiver as a means to affix a gate to an opposing fence post.

FIG. 26 shows a profile view of an extra deep cup 8 having a lip of cup 11 and a opening in the rear of the cup 10 sized to receive a the rim of a Deadbolt Lock Face Plate Assembly and an opening in the front of the cup 9.

FIG. 27 shows a side view of the position of the extra deep cup 8 installed in a vinyl post 7 along with deadbolt face plate assemblies 16 installed in the cup and on the face of said vinyl post said deadbolt face plates being held together by threaded deadbolt lock bolts 19 and having a deadbolt cylinder face plate 20 aligned to allow the throw of the deadbolt lock 17 to extend from said vinyl post.

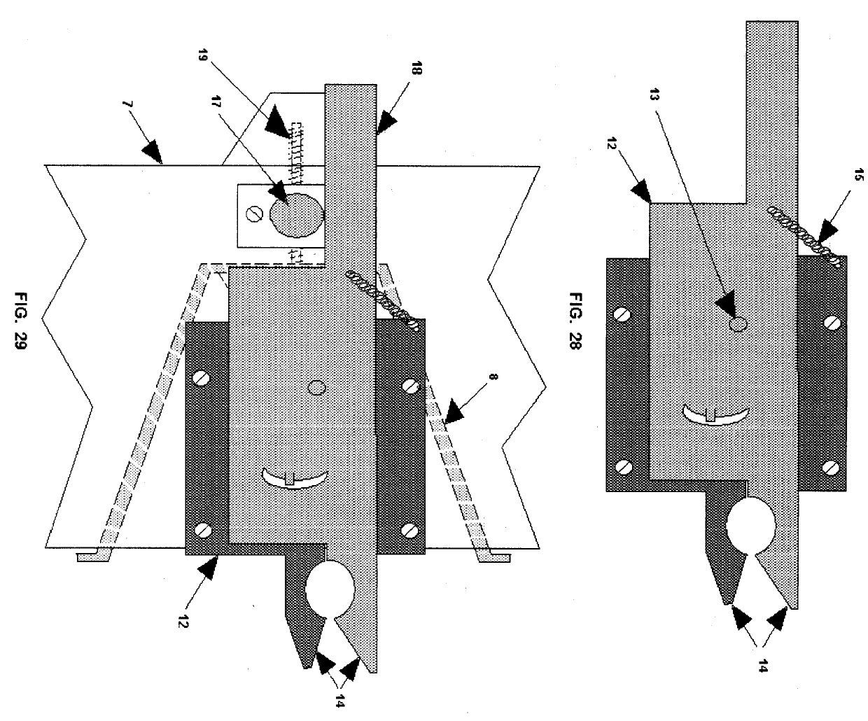

FIG. 28 shows a side view of the latch without hole 12 having a latch focrum 13 and a latch spring 15 that allow the latch jaws 14 to be separated to unlock a gate.

FIG. 29 shows the latch without hole 12 and an extra deep cup 8 installed on a vinyl post 7 with the throw of the deadbolt lock 17 positioned to stop the handle of the latch 67 to be significantly moved to separate the latch jaws 14 when the throw of the deadbolt lock 17 is extended from the vinyl post 7 and with deadbolt face plate assemblies being held together by threaded deadbolt lock bolts 19 FIG. 30 shows the preferred measurements of a wood gate cup 52 that is circularly shaped.

FIG. 31 shows a rear view of gate frame boards 53 with a deadbolt lock hole 55.

FIG. 32 shows a side view of a wood gate cup 52 that will be inserted into a fence board hole 56 that is on center with a deadbolt lock hole 55 with the said fence board hole 56 drilled in a fence board 54 and the deadlbolt lock hole 55 drilled in the gate frame board 53.

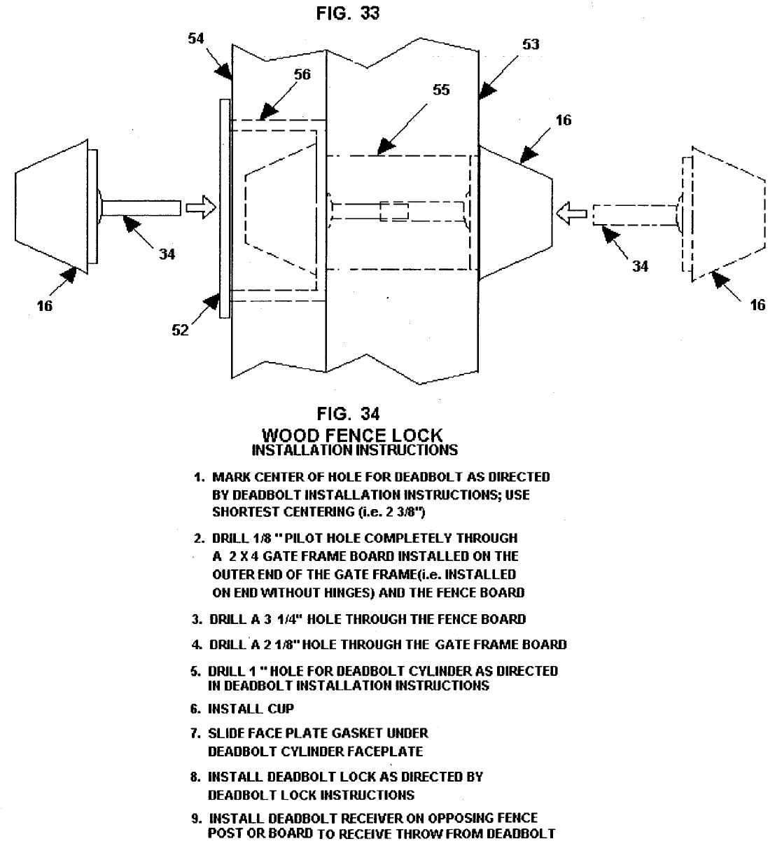

FIG. 33 shows a side view of parts of the invented wood gate lock where a wood gate cup 52 is installed into a fence board hole 56 in a fence board 54 over a deadbolt lock hole 55 in a gate frame board 53 where deadbolt lock face pate assemblies 16 having rear tumbler protrusions 34 are nested together in the deadbolt cylinder (not shown) to effectuate the operation of the deadbolt lock.

FIG. 34 shows the typical installation instructions for the invented wood gate lock.

All measurements disclosed herein are at standard temperature and pressure, at sea level on Earth, unless indicated otherwise. All materials used or intended to be used in a human being are biocompatible, unless indicated otherwise. The foregoing embodiments are presented by way of example only; the scope of the present invention is to be limited only by the following claims.

The inventors seek patent protection for the following combination of the invented system of parts. What is claimed by the inventor as being a new, innovative, and not obvious use and desired to be protected by Letters Patent of the United States is as follows:

1. Apparatus comprising a house door deadbolt lock and a flanged cup sized and shaped to provide the physical means to install a standard deadbolt lock preferably into a vinyl fence post for the purpose of locking and unlocking a fence gate by the extension and retraction of the throw of the deadbolt lock.

2. Apparatus comprising a house door deadbolt lock and two flanged cups, sized to provide the physical means to install a deadbolt lock preferably into a vinyl fence post for the purpose of locking and unlocking a fence gate by the extension and retraction of the deadbolt lock's throw.

3. An apparatus as specified in claim 1 or claim 2 that uses a receiver with a hole sized to fit and receive a deadbolt lock's throw with the throw's receiver preferably affixed to the gate frame to physically connect the stationary fence post to the gate frame by the extending of the deadbolt lock's throw into the throw receiver.

4. An apparatus as specified in claim 1 or claim 2 that uses a commonly available spring operated side mount jaws latch with a hole in the latch with said latch being affixed to the stationary fence post to physically connect the fence post to a gate frame having a latch strike bar.

5. An apparatus as specified in claim 1 that uses a commonly available spring operated side mount jaws latch with said latch being affixed to the fence post to physically connect the fence post to a gate frame that has a latch strike bar and said latch being prevented from opening by the extension of the deadbolt lock's throw under or over the handle of the latch.

6. An apparatus as specified in claim 2 that uses a commonly available spring operated side mount jaws latch with a hole in said latch and said latch affixed to the fence post to physically connect the fence post to the opposing gate frame that has a latch strike bar.

7. A lock kit of parts comprising a round or square or rectangular cup that is sized and shaped for the purpose of being used to install a deadbolt lock in a post to lock and unlock a fence gate.

8. A lock kit of parts comprising two round or square or rectangular cups that are sized and shaped for the purpose of being used to install a deadbolt lock to lock and unlock a fence gate.

9. A lock kit of parts for installing a deadbolt lock to lock and unlock a fence gate comprising a cup and a deadbolt throw receiver.

10. A lock kit of parts for installing a deadbolt lock to lock and unlock a fence gate comprising two cups and a deadbolt throw receiver

11. A lock kit of parts for installing a deadbolt lock to lock and unlock a fence gate comprising a cup and a gate latch.

12. A lock kit of parts for installing a deadbolt lock to lock and unlock a fence gate comprising two cups and a gate latch with a hole in the latch

13. A lock kit of parts comprising a gate latch with a hole in the latch sized and located to receive a deadbolt lock's throw; that is sized and shaped for the purpose of being used with a deadbolt lock to lock and unlock a fence gate.

14. A lock kit of parts for installing a deadbolt lock to lock and unlock a fence gate that contains one or more of the parts specified in one of claims 1 through 13 that also contains a standard deadbolt lock

15. A lock kit of parts for installing a deadbolt lock to lock and unlock a fence gate comprising a cup and a deadbolt Lock

16. A lock kit of parts for installing a deadbolt lock to lock and unlock a fence gate comprising two cups and a deadbolt lock.

17. The kit of any prior claim, further comprising other gate parts including hinges and gate rods to lock and unlock a fence gate.

18. A kit of parts developed to fashion alternative part combinations to lock or unlock a fence gate from ether side of a gate by use of a deadbolt lock with a means to extend or retract the throw of a commonly available deadbolt lock into a hole in a gate latch or over/under the handle of a gate latch or into a hole in a throw receiver.

19. The apparatus of claims 1 to 18 wherein the cup or cups have overlapping top flanges sized to fit snugly into holes drilled or cut into opposing sides of a hollow vinyl fence post with the top flange of each cup (i.e. lip of the cup) overlapping the hole in said fence post to prevent the opposing cups or a cup opposing a fence post wall from being drawn through the holes in the fence post.

20. The apparatus of claim 19, wherein the cup has an internal hole sized to permit the installation of a standard deadbolt lock.

21. A kit of parts containing cups as listed in claim 19 to provide the means to use a deadbolt lock installed in the cups in combination with other parts as a means to lock and unlock a fence gate.

22. A fence lock apparatus employing two cups to install a standard deadbolt lock in a position to lock and unlock a fence gate.

23. A fence lock apparatus employing one cup to install a standard deadbolt lock in a position to lock and unlock a fence gate.

24. A fence lock apparatus of employing two cups wherein the standard deadbolt lock has a throw, and the deadbolt lock is installed such that the throw is in a vertical position.

25. The apparatus of claim 1 including:
a round or square or rectangular cup for receiving a deadbolt faceplate assembly of a standard deadbolt lock that is designed and sized to be used to lock and unlock the standard 1½ inch to 1⅞ inch thick front door of a home; said deadbolt lock being made by various manufacturers such as the Kwickset Corporation, where the cup is intended to be installed in a hollow post to reduce the distance between the wall of the hollow post and the cup such as about 1½ inches to allow the installation of the deadbolt lock, the cup having a first diameter about 2½ inches to 4½ inches, a second diameter of about 2½ inches to 4¼ inches, and a depth of about 2½ inches to 3½ inches with a lip around the 2½ inch to 4¼ inch diameter extending about 1/8 inches to 1/4 inches inch around the 2½ inch to 4¼ inch cup diameter to prevent the cup from being pulled or pushed into the hollow post.

26. The apparatus of claim 1 to 25 wherein the cup is made of a plastic or vinyl material

27. The apparatus of claims 1 to 25 wherein the cup is made of PVC, or metal, or vinyl or other moldable material.

28. The apparatus of claims 2, 3, 6, 8 to 22, 24, 26, and 27 further comprising a second round or square or rectangular cup for receiving a deadbolt faceplate assembly of a standard deadbolt lock and for being received in a hollow post where the first cup has a first diameter of about 2½ inches to 4½ inches, a second diameter of about 2½ inches to 4½ inches, and a depth of about 1/2 inches to 1½ inches and the second cup having a first diameter of about 2½ inches to 4½ inches, a second diameter of about 2 1.2 inches to 4½ inches, and a depth of about 1½ inches to 2½ inches as necessary to reduce the distance between the first and second cup to between about 1¼ inches to 1⅞ inches to allow installation of a standard deadbolt lock into the cups that are installed into a hollow post.

29. The apparatus of claims 1 to 28 that contains a standard deadbolt lock that is designed and sized to be used to lock and unlock the standard 1¼ inch to 1⅞ inch thick front door of a home; said deadbolt lock being made by various manufacturers such as the Kwickset Corporation a division of the Black and Decker Corporation.

30. The apparatus of claims 1, 2 and 29 further comprising a receiver.

31. The apparatus of claims 1, 2 and 29, further comprising a plastic gate.

32. The apparatus of claims 1, 2, and 29, further comprising a fence containing a hollow post.

33. The apparatus of claims 1, 2, and 29, further comprising a plastic gate and a plastic fence containing a hollow post.

33 The apparatus of claims 1, 2, 7, and 8, further comprising the standard deadbolt lock specified in claim 29.

34. The cup apparatus of claims 1 and 2 wherein the first diameter is greater than the diameter of the deadbolt faceplate assembly of a standard deadbolt lock and the second diameter is greater than the first diameter, and a lip extends from the first diameter to the second diameter such that a hole drilled in the hollow post can vary in diameter between the first diameter and the second diameter.

35. Apparatus for locking a gate, comprising:
a latch and including a standard deadbolt lock that is designed and sized to be used to lock and unlock the standard 1½ inch to 1⅞ inch thick front door of a home; the latch also including a hole therein for receiving a throw of a standard deadbolt, wherein when properly installed the latch cannot be moved to open a gate with which it operates when the throw is received in the hole.

36. A round or square or rectangular cup designed for gates with said cup having a lip about 1/8 inches to 1/4 inches around the first diameter of the cup with the first diameter of the cup being about 2½ to 4¼ inches, a second diameter of about 2½ inches to 4½ inches, and a depth of about 2½ inches to 3½ inches or alternately having a first diameter of about 3¼ inches, a second diameter of about 3 inches, and a depth of about 1/12 inches to 2½ inches.

37. An offset receiver installed on a gate and a standard deadbolt lock installed in an opposing stationary hollow post as specified in claims 1 and 2 with said offset receiver having a hole therein sized to receive the throw of the standard deadbolt to physically connect the gate to the hollow post thereby preventing the gate from opening.

38. Apparatus including:
a round or square or rectangular cup for receiving a deadbolt faceplate assembly of a deadbolt lock and for being received in a hollow post, the cup preferably having a first diameter of about 4¼ inches, a second diameter of about 3¼ inches, and a depth of about 2½ inches to 3½ inches

39. The apparatus of claim 38 further comprising the deadbolt lock.

40. The apparatus of claim 39 further comprising the hollow post.

41. The apparatus of claim 40 further comprising a gate that is locked by the deadbolt lock.

42. The apparatus of claim 41 wherein a sliding throw operates to lock the gate and the deadbolt lock, when locked prevents the sliding throw from unlocking the gate.

43. The inventions substantially as shown and described herein.”
